(19) United States
(12) Patent Application Publication
(10) Pub. No.: US 2010/0083976 A1
(43) Pub. Date: Apr. 8, 2010

(54) Method and apparatus for completing a French manicure

(76) Inventor: Maryann Montana-Selers, Doylestown, PA (US)

Correspondence Address: SAND & SEBOLT, AEGIS TOWER, SUITE 1100, 4940 MUNSON STREET, NW, CANTON, OH, 44718-3615, US

(21) Appl. No.: 12/287,127

(22) Filed: Oct. 6, 2008

(51) Int. Cl. A45D 29/00; B43M 11/04

(52) U.S. Cl. 132/200; 132/285; 401/138; 401/139; 132/73

(57) ABSTRACT

The nail polish applicator of the present invention broadly comprises a body having a cavity, an application tip connected to the body and in fluid communication with the cavity, a polish contained in the cavity, a channel interposed between the cavity and the application tip, and wherein the application tip is sized to apply polish to a nail. The present invention also broadly comprises a method of completing a French manicure or French pedicure including the steps of: providing a nail polish applicator with a body having a cavity with a fluid, an application tip, and a channel interconnecting the cavity and the application tip, locating the application tip on a first side of a nail tip, and sliding the application tip from the first side to a second side of the nail tip.

### BACKGROUND OF THE INVENTION

1. Technical Field

The invention relates generally to a method and apparatus for applying nail polish. More particularly, the invention relates to a method and apparatus for completing a French manicure or pedicure. Specifically, the invention relates to a method and apparatus which is capable of easily applying a thin layer of nail polish to the tip of a nail.

2. Background Information

Manicures may date back hundreds of years to India and China. The modern manicure is a cosmetic treatment for the hands, nails, or both. A manicure generally consists of filing, polishing, and painting the fingernails, but may also include application of acrylics or artificial nail tips. A pedicure is a similar treatment performed on the foot and toe nails, which generally includes the same procedures.

Nail polish is generally sold in small bottles where the bottle cap includes a brush extending from the inner portion of the cap and into the nail polish. When nail polish is applied, the user holds the cap end, dips the brush into the polish, and applies the polish with a stroke of the brush, similar to a paint brush.

The French manicure is thought to have its origin in the 1700's and were excessively popular in the 1920's and 1930's. The French manicure is essentially a combination of two colors painted on each nail. Preferably, the base of the nail (nail bed area) is painted pink and the portion of the nail extending beyond the nail bed is painted white, which provides the appearance of a well-defined, natural nail. As an alternative to the pink base color, the base may be left unpainted or painted with a flesh-toned color.

Creating an attractive French manicure requires the precise and steady hand of a professional. In particular, the base of the nail is painted with a pink or similar flesh-toned polish and allowed to dry. Next, the tip of the nail, or the portion extending beyond the end of the nail bed, is precisely painted white. A great deal of precision is needed so that the intersection of the pink base and the white tip is located at the exact point where the nail bed terminates. Further, the nail bed naturally curves, requiring the white tip to be painted with an arc-like shape and substantially increases the difficulty of producing the precise intersection and the perfect French manicure. One of the main concerns with a professional French manicure is the cost, ranging anywhere from $10 to upwards of $40 at high-end salons.

A cost-saving alternative to the professional French manicure is for the consumer to paint her own nails. However, painting her own nails is difficult and time consuming for a couple of reasons. First, the self-application is time consuming because she will generally need to wait until one hand is dry before moving onto the other hand. This is due to the fact that the hand that was just painted will still be wet and must now be used to apply polish to the other hand, thereby running the risk of smearing the polish or the polish dripping. Second, the procedure is difficult because she is forced to either bend her fingers to direct the nails back towards her, which is uncomfortable, or paint her nails from behind. When she is painting from behind her nail, her nails are pointed away from her, which means it is difficult to accurately and precisely paint the white tips. Finally, painting her own nails is extremely difficult due to the lack of dexterity in one of her hands. Since people tend to be stronger and more precise with one hand over the other, painting with the weaker hand may lead to uneven lines and unsatisfactory results. The consumer will then be left with one hand having an acceptable French manicure and one hand with an unacceptable French manicure.

Therefore, a need exists for a quick and efficient way for professionals and home consumers to produce a precise French manicure without the expense and time of a solon or traditional nail polish brush.

### SUMMARY OF THE INVENTION

The nail polish applicator of the present invention broadly comprises a body having a cavity, an application tip connected to the body and in fluid communication with the cavity, a polish contained in the cavity, a channel interposed between the cavity and the application tip, and wherein the application tip is sized to apply polish to a nail. The application tip further includes a first end secured to the channel and a second end distal the channel for dispensing a liquid on the nail. The first end may be wider than the second end and tapered from the first end to the second end. Further, the application tip may be a right triangular prism and composed of a porous material.

The body may be compressible to regulate the flow of liquid through the channel and the body further includes a finger locating portion radially outward of the body and proximate the channel and the application tip. The second end of the application tip may also have an arcuate shape.

The present invention also broadly comprises a method of completing a French manicure or French pedicure including the steps of: providing a fluid applicator with a body having a cavity with a fluid, an application tip, and a channel interconnecting the cavity and the application tip, locating the application tip on a first side of a nail tip, and sliding the application tip from the first side to a second side of the nail tip. The method may further include the steps of compressing the body prior to locating the application tip on the first side of the nail tip and compressing the body after locating the application tip on the first side of the nail tip. The method may also include the step of painting a nail bed a color different than the nail tip before locating the application tip on the first side of the nail tip and wherein the nail is a fingernail or a toenail.

The present invention further broadly comprises a method of completing a French manicure or French pedicure including the steps of: providing a fluid applicator with a body having a cavity with a fluid, an application tip complimentarily shaped to a nail, and a channel interconnecting the cavity and the application tip, locating the application tip on a tip of a nail, pressing the nail polish applicator in a direction towards the nail tip, and dispensing the fluid onto the nail tip. The method may further include the step of compressing the body prior to locating the application tip on the nail tip and compressing the body after locating the application tip on the nail tip. Further, the method may include the step of lifting the nail polish applicator from the nail tip and painting a nail bed a color different than the nail tip before locating the application tip on the first side of the nail tip. Finally, the nail may be a fingernail or a toenail.

### BRIEF DESCRIPTION OF THE DRAWINGS

The preferred embodiments of the invention, illustrative of the best modes in which Applicant has contemplated applying the principles of the invention, are set forth in the following description and are shown in the drawings.

FIG. 1 is a side view of a preferred embodiment nail polish applicator;

FIG. 2 is a front view of a preferred embodiment nail polish applicator;

FIG. 3 is a front view of the preferred embodiment nail polish applicator of FIG. 2 with portions cut away and in section;

FIG. 4 is a top view of a preferred embodiment nail polish applicator being located on the tip of a user's fingernail in preparation for completing a French manicure;

FIG. 5 is a side view of a preferred embodiment nail polish applicator located on the tip of a user's fingernail in preparation for completing a French manicure;

FIG. 5A is a side view of a preferred embodiment nail polish application located on the tip of a user's fingernail at approximately a forty-five degree angle in preparation for completing a French manicure;

FIG. 6 is a top view of a preferred embodiment nail polish applicator located on the tip of a user's finger nail and being moved from the left to the right to produce a French manicure;

FIG. 7 is a side view of a second preferred embodiment nail polish applicator;

FIG. 8 is a front view of a second preferred embodiment nail polish applicator;

FIG. 9 is a top view of a second preferred embodiment nail polish applicator being located on the tip of a user's fingernail in preparation for completing a French manicure; and,

FIG. 10 is a top view of a second preferred embodiment nail polish applicator being removed from the tip of a user's fingernail after completing a French manicure.

### DESCRIPTION OF THE PREFERRED EMBODIMENTS

At the outset, it should be appreciated that like drawing numbers on different drawing views identify identical, or functionally similar, structural elements of the invention. While the present invention is described with respect to what is presently considered to be the preferred embodiments, it is to be understood that the invention as claimed is not limited to the disclosed aspects.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

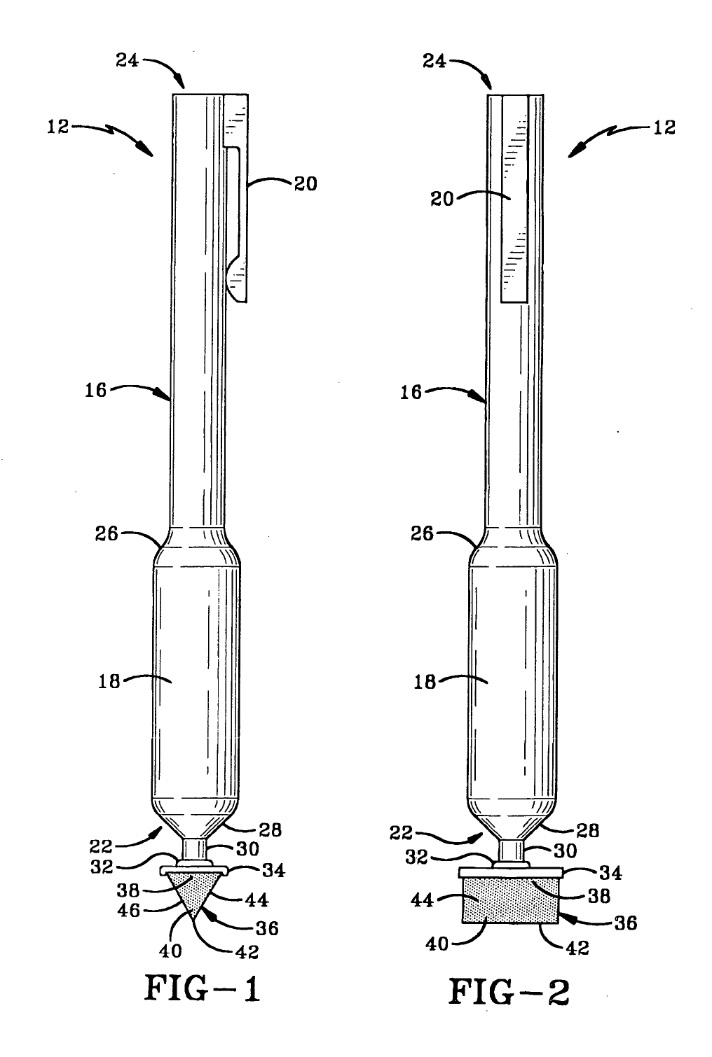

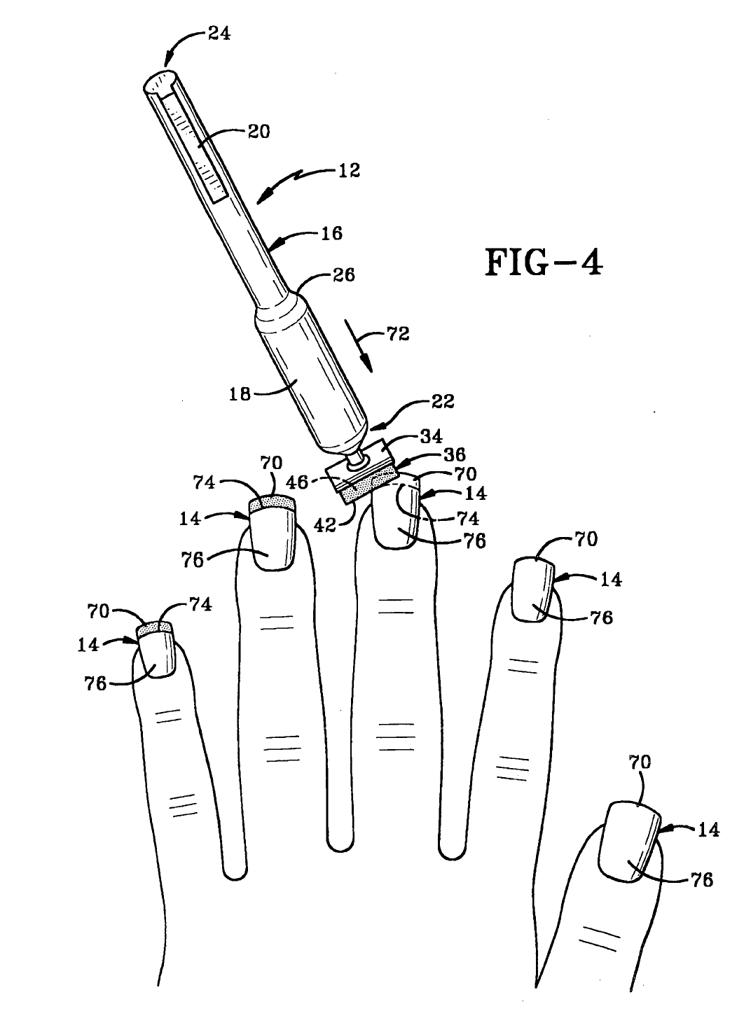

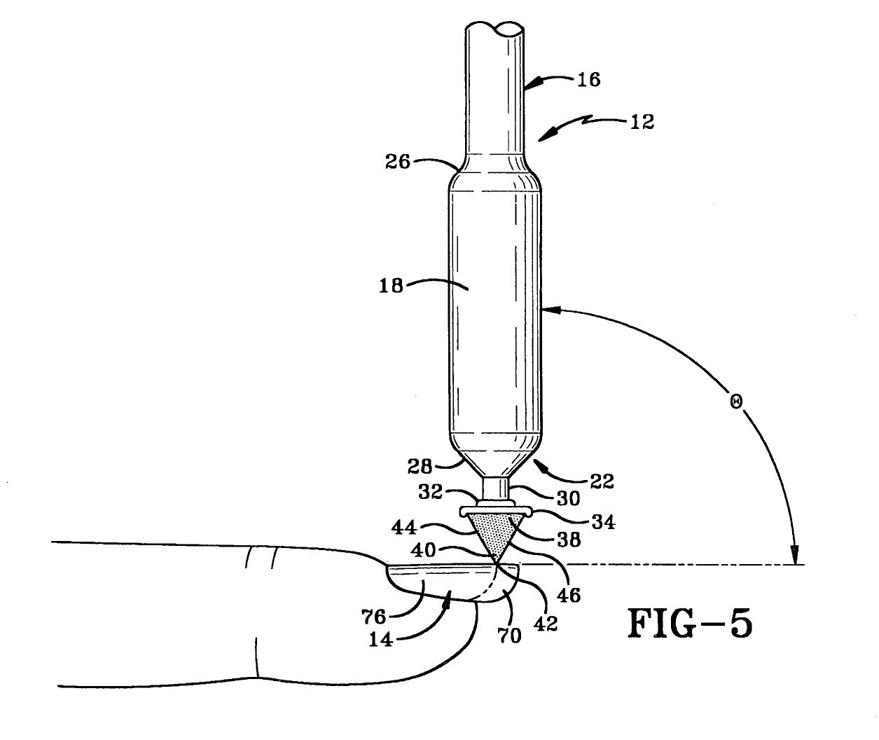

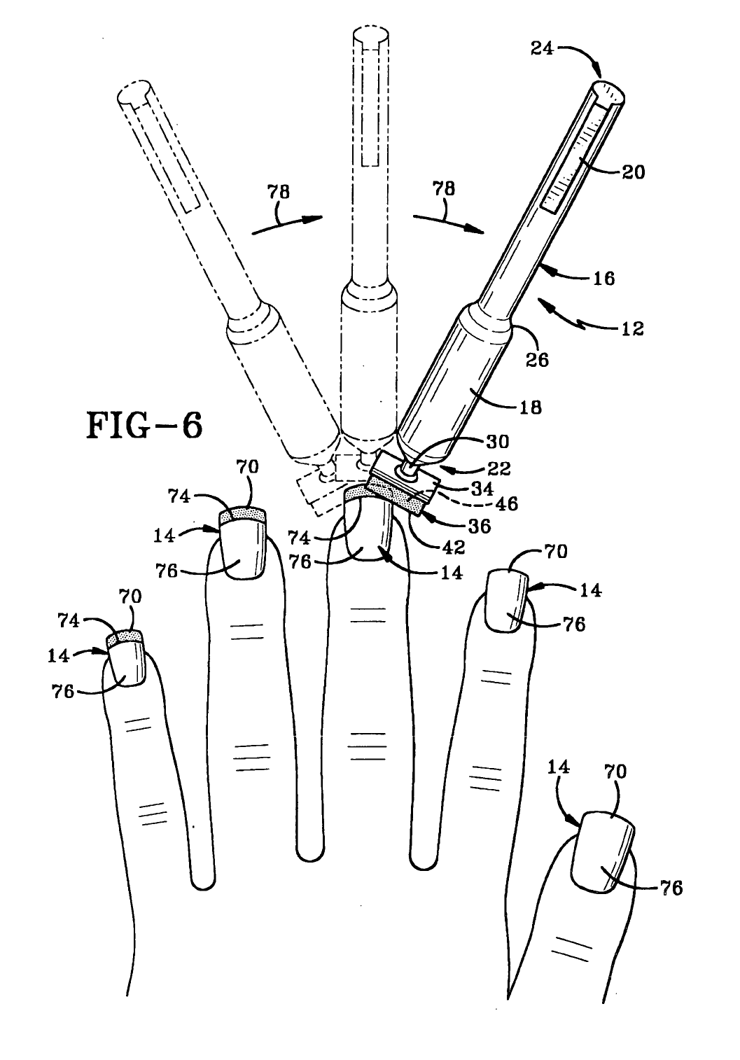

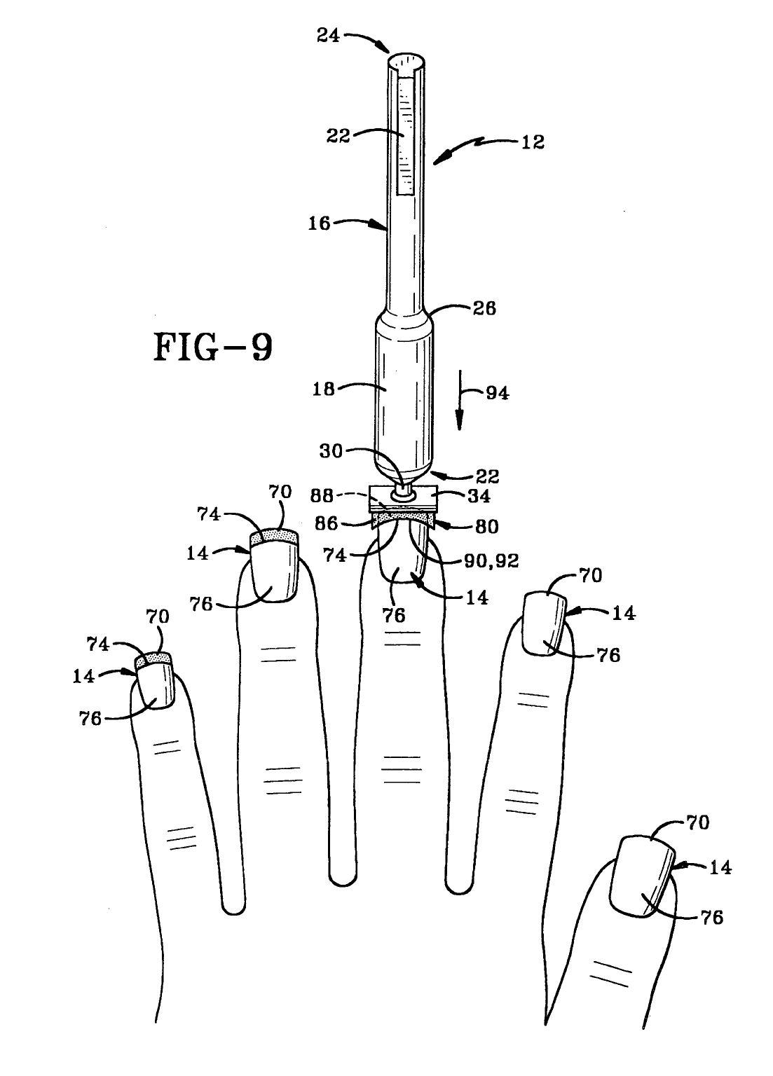

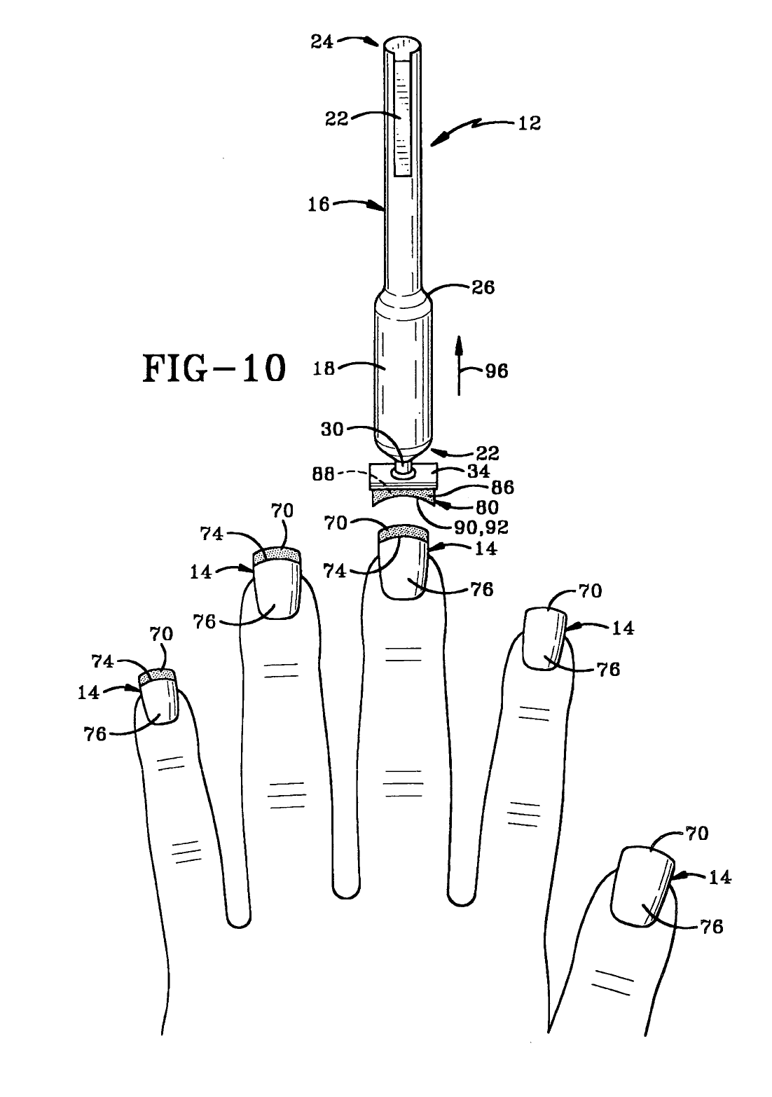

The nail polish applicator of the present invention is indicated generally at 12, as is particularly shown in FIGS. 1 through 10 being used to complete a French manicure on nails 14. Nail polish applicator 12 includes a body 16, a finger locating portion 18, and a clip 20. Finger locating portion 18 is located proximate a first end 22, while clip 20 is located on a second end 24 which is on the opposing side of body 16. Body 16 is preferably cylindrical in shape and of a length which a user can comfortably and confidently control. While the body is preferably cylindrical, the body may be any shape or length, which is within the spirit and scope of the present invention as claimed.

Finger locating portion 18 is preferably shaped complimentary to body 16. Further, the finger locating area is wider than body 16 and includes a first tapered end 26 and a second tapered end 28. First tapered end 26 radially expands from body 16 to finger locating portion 18. Conversely, second tapered end 28 radially contracts from finger locating portion 18 to a channel 30. Channel 30 is preferably cylindrical and has a diameter smaller than both the finger locating portion and the body. The channel also includes a neck 32 connected on the end of the channel opposite second tapered end 28. Neck 32 is then connected to a tip mount 34.

In accordance with one of the main features of the invention, tip mount 34 secures an application tip 36. Application tip 36 has a first end 38 and a second end 40. The application tip is preferably a right triangular prism and first end 38 is wider than second end 40. Specifically, application tip 36 tapers evenly from first end 38 to second end 40. Second end 40 terminates at a point 42. The application tip also includes a first side wall 44 and a second side wall 46. As noted supra, the first and second side walls taper from first end 38 to second end 40 and culminate at point 42. Advantageously, the preferred embodiment application tip provides two separate surfaces for transferring nail polish. In particular, first side wall 44 and second side wall 46 are each arranged to receive polish and transfer the polish to a fingernail. Further, the application tip can be applied in a straight up and down motion whereby fluid is transferred to the fingernail through point 42.

The application tip is preferably composed of foam, but may also be a sponge, poly foam, polyurethane, or any other porous material which is suitable for allowing a fluid to flow from first end 38 to second end 40, first side wall 44, and second side wall 46. Further, application tip 36 is resilient and slightly deformable to allow the user to firmly and accurately locate the application tip on a nail and provide smooth fluid flow.

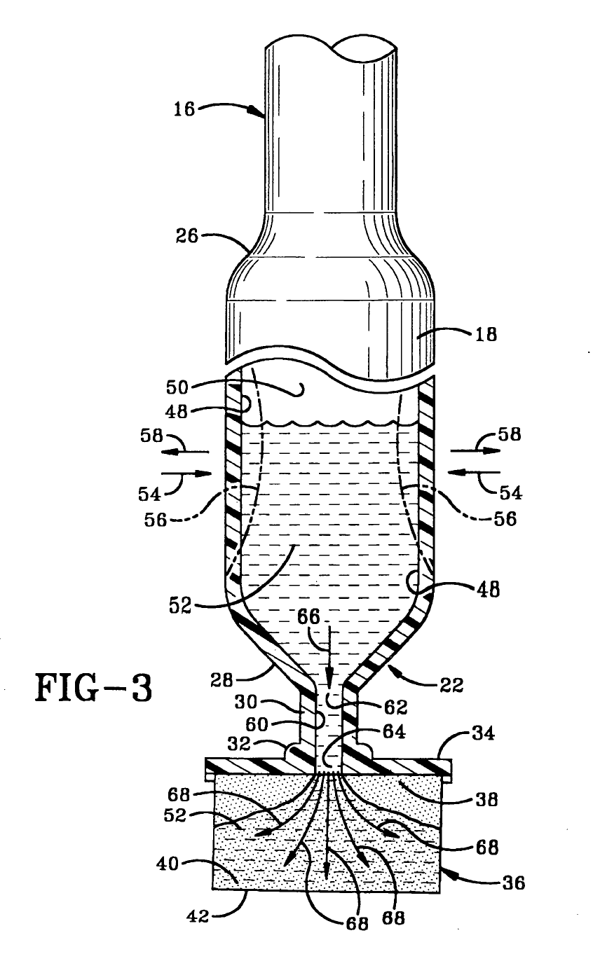

In accordance with another main feature of the present invention and averting to FIG. 3 where a partial cross-section of the nail polish applicator is shown, finger locating portion 18 includes an inner wall 48 partially defining a cavity 50. Inner wall 48 and cavity 50 are both preferably cylindrical. The inner wall is compressible and deformable to regulate the flow of a fluid 52 within the cavity. In particular, inner wall 48 is compressible towards cavity 50 and fluid 52 in the direction associated with arrows 54. The inner wall deforms to a distance approximately equal to an arcuate line 56. Since finger locating portion 18 is resilient, inner wall 48 expands radially back to the original state in the direction associate with arrows 58 when the compression force is released.

Channel 30 includes an inner wall 60 which begins at the intersection of second tapered end 28 and the channel. The inner wall has an inlet aperture 62 connecting cavity 50 and channel 30. Further, an outlet aperture 64 connects the channel to application tip 36, and particularly at first end 38 of the application tip. Thus, a fluid connection is created between body 16, cavity 50, channel 30, and application tip 36.

Having described the structure of the present invention, a preferred method of completing a French manicure or pedicure will be described and should be read in light of FIGS. 1 through 6. Although the method is described as a sequence of steps for clarity, no order should be inferred unless explicitly stated, where the first step is providing nail polish applicator 12 with body 16 having cavity 50 therein and finger locating portion 18. In accordance with yet another main feature of the invention, the cavity includes fluid 52, which is preferably nail polish, application tip 36, and channel 30 interconnecting the cavity and the application tip. The next step is shaking applicator 12 to ensure even mixing of the fluid. Next, finger locating portion 18 is compressed in the direction associated with arrows 54 until inner wall 48 reaches the maximum bending point indicated at approximately arcuate line 56.

When finger locating portion 18 is compressed, cavity 50 is decreased in size and thereby increases the flow of fluid in the direction associated with an arrow 66 into inlet aperture 62. The fluid is then directed through channel 30 along inner wall 60 and through outlet aperture 64. After passing through outlet aperture 64, the fluid is forced into first end 38 of application tip 36 and radially distributed towards second end 42 as indicated by arrows 68. Since finger locating portion 18 is resilient, inner wall 48 springs back to the relaxed position when the finger locating portion is no longer being compressed.

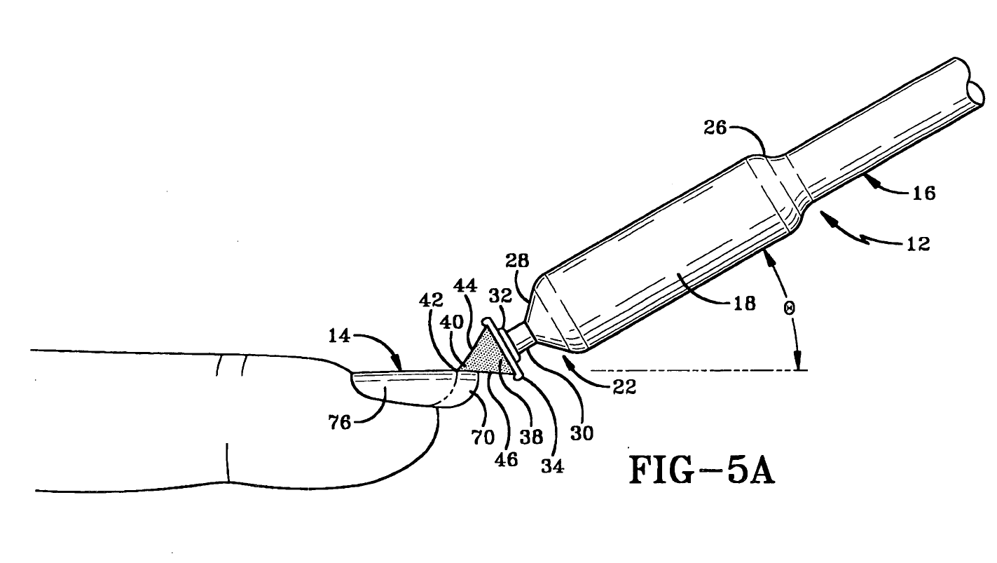

The user then locates nail polish applicator 12 on one side of nail 14 at a nail tip 70 by moving the applicator in the direction associated with an arrow 72. The applicator is placed on nail tip 70 at an angle θ approximately equal to the angle of side walls 44 and 46. In a preferred embodiment, angle θ is approximately 90 degrees (FIG. 5). While in another preferred embodiment, angle θ is approximately 45 degrees (FIG. 5A). Second end 40 and point 42 are located along a generally arcuate line 74. Arcuate line 74 represents the separation line between a nail base 76 and nail tip 70. Next, the user slides the nail polish applicator along arcuate line 74 in the direction associated with arrows 78 and fluid 52 is transferred from second side wall 46 and point 42 onto nail tip 70. The user then removes nail polish applicator 12 from the nail tip and is left with a nail tip 70 which has a smooth and arcuate boundary at arcuate line 74. Thus, the method easily and efficiently provides application of nail polish to the tip of a finger nail.

While the preferred method is described as having the nail polish applicator traverse the nail tip in the direction associated with arrows 78, it is within the spirit and scope of the invention as claimed for the nail polish applicator to traverse the nail in the opposite direction. Further, while the preferred embodiment includes compression of finger locating portion 18 prior to locating application tip 36 on finger nail 70, the user may locate the application tip on the finger nail and then compress finger locating portion 18 to discharge fluid from the cavity.

Having now described the structure and operation of the first embodiment, only those portions of the remaining embodiment which are different from the first embodiment are described in detail. Likewise, similar numerals refer to similar parts throughout the various embodiments.

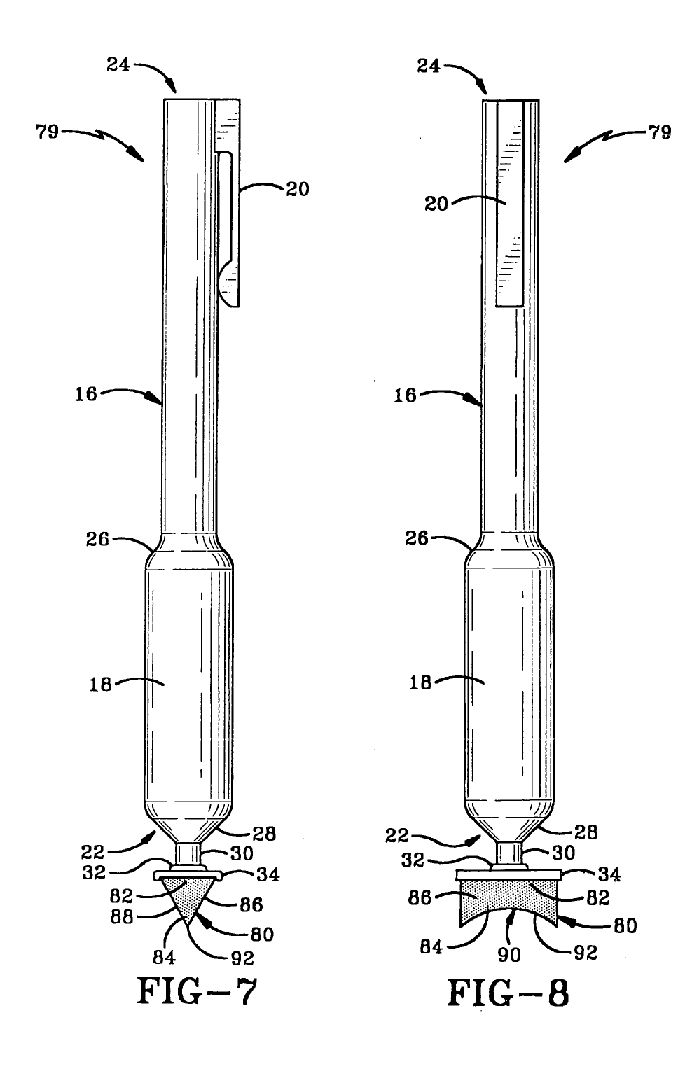

In accordance with a second embodiment of the present invention shown specifically in FIGS. 7 and 8, a nail polish applicator 79 includes an application tip 80 with a first end 82 and a second end 84. A first side wall 86 and a second side wall 88 taper at an angle from first end 82 and second end 84. First end 82, second end 84, first side wall 86, and second side wall 88 all function similar to application tip 36, whereby fluid is transferred through the application tip to the first and second side walls and a point 92. However, second end 84 is generally concave and complimentarily shaped to a nail tip and includes. In particular, second end 84 is of a length and width similar to a nail tip and an arched portion 90 which is shaped complimentary to the natural arch of a nail. Thus, application tip 80 can completely cover the tip of a nail without any additional movement.

Application tip 80 is also preferably composed of foam, but may be a sponge, poly foam, polyurethane, or any other porous material which is suitable for allowing a fluid to flow from first end 82 to second end 84, first side wall 86, and second side wall 88. Further, application tip 80 is resilient and slightly deformable to allow the user to firmly and accurately locate the application tip on a nail and provide smooth fluid flow.

Having described the structure of the second embodiment, a preferred method of completing a French manicure or French pedicure will be described and should be viewed in light of FIGS. 3 and 7 through 10. Although the method is described as a sequence of steps for clarity, no order should be inferred unless explicitly stated, where the first step is providing nail polish applicator 79 with body 16 having cavity 50 therein and finger locating portion 18. In accordance with yet another main feature of the invention, the cavity includes fluid 52, which is preferably nail polish, application tip 80 complimentarily shaped to nail 14 with arched portion 90, and channel 30 interconnecting the cavity and the application tip. The next step is shaking applicator 79 to ensure even mixing of the fluid. Next, finger locating portion 18 is compressed inward until inner wall 48 reaches the maximum bending point indicated at arcuate line 56.

When finger locating portion 18 is compressed, cavity 50 is decreased in size and thereby increases the flow of fluid in the direction associated with an arrow 66 into inlet aperture 62. The fluid is then directed through channel 30 along inner wall 60 and through outlet aperture 64. After passing through outlet aperture 64, the fluid is forced into first end 82 of application tip 80 and radially distributed towards second end 84 as indicated by arrows 68. Since finger locating portion 18 is resilient, inner wall 48 springs back to the relaxed position when the finger locating portion is no longer being compressed.

The user then locates nail polish applicator 79 on nail tip 70 by moving the applicator in the direction associated with an arrow 94. The applicator is preferably placed on nail tip 70 in a perpendicular orientation, but may also be located at an angle similar to angle θ (FIG. 5A). In particular, arched portion 90 and point 92 are located along generally arcuate line 74. Arcuate line 74 represents the separation line between nail base 76 and nail tip 70. Since the nail polish applicator is of a size and shape similar to nail tip 70, the painting process is completed without further operation. Specifically, point 92 is located proximate arcuate line 74 and helps to produce a clean and even intersection between nail base 76 and nail tip 70.

The user then removes nail polish applicator 79 from the nail tip by lifting the applicator in the direction associated with an arrow 96. Accordingly, the user is left with a nail tip 70 which has a smooth and arcuate boundary at arcuate line 74. Thus, the method easily and efficiently provides application of nail polish to the tip of a finger nail.

While the preferred method is described as requiring compression of finger locating portion 18 prior to locating application tip 80 on finger nail 70, the user may locate the application tip on the finger nail and then compress finger locating portion 18 to discharge fluid from the cavity. Further, while the first and second embodiments are shown and described being used to apply a French manicure to a fingernail, it is within the spirit and scope of the present invention as claimed to use the first or second preferred embodiment nail polish applicator to provide a French pedicure to toenails.

Accordingly, the manicure apparatus and method are an effective, safe, inexpensive, and efficient device that achieves all the enumerated objectives of the invention, provides for eliminating difficulties encountered with prior art devices, systems, and methods, and solves problems and obtains new results in the art.

In the foregoing description, certain terms have been used for brevity, clearness, and understanding; but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

Having now described the features, discoveries, and principles of the invention, the manner in which the manicure apparatus and methods are constructed and used, the characteristics of the construction, and the advantageous new and useful results obtained; the new and useful structures, devices, elements, arrangement, parts, combinations, and methods are set forth in the appended claims.

What is claimed is:

1. A nail polish applicator comprising:
a body having a cavity;
an application tip connected to the body and in fluid communication with the cavity;
a polish contained in the cavity;
a channel interposed between the cavity and the application tip; and,
wherein said application tip is sized to apply polish to a nail.

2. The nail polish applicator of claim 1 wherein said application tip further comprises a first end secured to the channel and a second end distal the channel for dispensing a liquid on the nail.

3. The nail polish applicator of claim 2 wherein the first end is wider than the second end.

4. The nail polish applicator of claim 2 wherein the application tip is tapered from the first end to the second end.

5. The nail polish applicator of claim 1 wherein the application tip is a right triangular prism.

6. The nail polish applicator of claim 1 wherein the application tip is porous.

7. The nail polish applicator of claim 1 wherein the body is compressible to regulate the flow of liquid through the channel.

8. The nail polish applicator of claim 1 wherein the body further comprises a finger locating portion proximate the channel and the application tip.

9. The nail polish applicator of claim 8 wherein the finger locating portion is radially outward of the body.

10. The nail polish applicator of claim 2 wherein the second end is generally arcuate.

11. A method of completing a French manicure or French pedicure comprising the steps of:
providing a fluid applicator with a body having a cavity with a fluid, an application tip, and a channel interconnecting said cavity and said application tip;
locating said application tip on a first side of a nail tip; and,
sliding said application tip from said first side to a second side of said nail tip.

12. The method of claim 11 further comprising the step of compressing the body prior to locating the application tip on the first side of the nail tip.

13. The method of claim 11 further comprising the step of compressing the body after locating the application tip on the first side of the nail tip.

14. The method of claim 11 further comprising the step of painting a nail bed a color different than the nail tip before locating the application tip on the first side of the nail tip.

15. The method of claim 11 wherein the nail is a fingernail or a toenail.

16. A method of completing a French manicure or French pedicure comprising the steps of:
providing a fluid applicator with a body having a cavity with a fluid, an application tip complimentarily shaped to a nail, and a channel interconnecting said cavity and said application tip;
locating said application tip on a tip of a nail;
pressing said fluid applicator in a direction towards said nail tip; and,
dispensing said fluid onto said nail tip.

17. The method of claim 16 further comprising the step of compressing the body prior to locating the application tip on the nail tip.

18. The method of claim 16 further comprising the step of compressing the body after locating the application tip on the nail tip.

19. The method of claim 16 further comprising the step of lifting the fluid applicator from the nail tip.

20. The method of claim 16 further comprising the step of painting a nail bed a color different than the nail tip before locating the application tip on the first side of the nail tip.
